(19) United States
(12) Patent Application Publication
(10) Pub. No.: US 2025/0248402 A1
(43) Pub. Date: Aug. 7, 2025

(54) HERBICIDAL COMPOSITIONS AND METHODS FOR CONTROLLING WEEDS

(71) Applicants: UPL Mauritius Limited, Port Louis (MU); UPL Europe Supply Chain GMBH, Rotkreuz/Risch (CH)

(72) Inventors: Stephen SKORCZYNSKI, Audubon, PA (US); Cody GRAY, Durham, NC (US); Ryan HENRY, Durham, NC (US); Prakash Mahadeo JADHAV, Audubon, PA (US); Vraj PATEL, Audubon, PA (US)

(21) Appl. No.: 19/042,530

(22) Filed: Jan. 31, 2025

Related U.S. Application Data
(60) Provisional application No. 63/548,950, filed on Feb. 2, 2024.

(51) Int. Cl. A01N 43/707; A01N 25/10; A01N 43/653; A01P 13/00

(52) U.S. Cl. CPC A01N 43/707; A01N 25/10; A01N 43/653; A01P 13/00

(57) ABSTRACT

An herbicidal composition comprising a triazolone herbicide, a triazinone herbicide and at least an agriculturally acceptable excipient is disclosed in this application. In addition, the application described a composition comprising a triazolone herbicide, a triazinone herbicide, a crystal growth inhibitor, and at least an agriculturally acceptable excipient. Further, the application disclose methods of controlling undesirable vegetation comprising applying the composition.

### CROSS REFERENCE TO RELATED APPLICATION

This application claims priority to U.S. Provisional Application Ser. No. 63/548,950, filed Feb. 2, 2024, the disclosure of which is expressly incorporated herein by reference.

### TECHNICAL FIELD

The present disclosure relates to an herbicidal composition comprising a triazolone herbicide and a triazinone herbicide. Further, the present disclosure relates to a process for preparing herbicidal composition and method of use thereof.

### BACKGROUND OF INVENTION

Crop protection requires constant monitoring of the sown crop for various pests. Further, weeds are a persistent problem that needs constant monitoring. Agriculturalists usually control or suppress weed growth by using herbicides at either the pre-plant stages or after sowing or both depending on the weed type and the level of infestation. Current practices include combining herbicides that have different modes of action, which allows for broader spectrum of control and allow for resistance management. The combinations used currently do not effectively handle resistant and persistent weeds. There is therefore a need in the art for improved combinations with enhanced efficacy and a broader spectrum of weed control.

Combinations of herbicides are used to control a broader range of weeds. However, the combination of herbicides may not always result in the desired effect. Combination of herbicides may lead to an additive effect or an antagonistic effect. It may also result in phytotoxicity to the crops making it an undesirable combination. Agronomists must therefore carefully select the herbicides that can be combined to offer an effective control of weeds while having no phytotoxic effect on the crop and reduce the chances of development of herbicide resistant weeds.

Compositions containing combinations of two or more herbicides have been known in the art, but problems such as the physical instability of such mixtures during manufacture, shelf life or dilution at the time of application can adversely impact the efficacy associated with the herbicide combination.

In addition to selection of the appropriate herbicides, it is important to identify the appropriate formulation type for the specific combination of herbicides. Suspension concentrate (SC) formulations, for example, are a solid active ingredient dispersed in water. SCs have grown in popularity due to benefits such as absence of dust, ease of use and effectiveness when compared to formulation types such as emulsifiable concentrate (EC) and wettable powder (WP) formulations. To formulate a stable SC, the active ingredient must remain insoluble under all temperature conditions.

Several problems arise when active ingredients are to be formulated as suspension concentrates. A major drawback of formulating a slightly water-soluble ingredient as an aqueous SC is Ostwald ripening, which refers to instances in which the larger crystals of the ingredient grow while the smaller crystals dissolve. Ostwald ripening is generally facilitated by dissolution of the active substances into the continuous aqueous phase, which can occur even if the solubility of the active substances in water is low. However, high solubility of the active substances in water increases the incidence of Ostwald ripening for active substances that are capable of Ostwald ripening. Physical instability is one manifestation of Ostwald ripening. Further, drawbacks to Ostwald ripening include limited utility of the formulation because an acceptable shelf-life may not be obtained. For instance, a two-year shelf-life is typically needed for a successful commercial product in agrochemicals. Also, crystals that grow too large may plug spray equipment and may not stay suspended in the spray tank or concentrated formulation. Gelling, caking, and settling due to large crystals being formed in the final suspension concentrate formulation result in instability, difficulty in processing and unreliability in usage.

Thus, formulating suspension concentrate compositions of a triazolone herbicide and a triazinone herbicide, wherein this gelling, caking, and settling are minimized is crucial to the stability of suspension concentrates which is then necessary to obtain an even distribution of active compounds for application. Selection of appropriate partners/constituents constituting the suspension concentrate plays a critical role towards stability of the composition.

Therefore, there is a need to develop a stable agrochemical compositions of a triazolone herbicide and a triazinone herbicide which do not undergo crystal formation of the active and remain stable throughout the shelf life as well as during application.

### SUMMARY OF INVENTION

In an aspect, the present disclosure provides an herbicidal composition comprising a triazolone herbicide and a triazinone herbicide.

In another aspect, the present disclosure provides an herbicidal composition comprising a triazolone herbicide, a triazinone herbicide and at least an agriculturally acceptable excipient. In another aspect, the herbicidal composition further comprises a crystal growth inhibitor, which prevents crystal growth in the composition upon storage.

In one aspect of an embodiment, the present composition is in the form of a suspension concentrate.

In yet another embodiment, the instant disclosure provides a process for preparing an herbicidal composition comprising a triazolone herbicide and a triazinone herbicide.

In yet another embodiment, the instant disclosure provides a method controlling weeds at a locus, the method comprising applying to the locus an herbicidal composition described herein.

Furthermore, the present disclosure provides a method of controlling chlorotriazine resistant or tolerant weeds comprising applying a triazolone herbicide, a triazinone herbicide, or an herbicidal composition comprising a triazolone herbicide and a triazinone herbicide.

In yet another embodiment, the instant disclosure provides a method of increasing yield in a crop, the method comprising applying, to the locus of a crop, a herbicidal composition or an agrochemical formulation described herein.

In yet another embodiment, the instant disclosure provides a method of improving the plant health, the method comprising, applying to the plant or to the locus at which said plant is growing, or intended to grow, an herbicidal composition described herein.

### DETAILED DESCRIPTION OF INVENTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiment, the combination or formulation described includes or comprises or consists of or consists essentially of or consists substantially of the specific components recited therein, to the exclusion of other ingredients or excipients not specifically recited therein.

The term “herbicide” as used herein, shall mean an active ingredient that kills, controls or otherwise adversely modifies the growth of weeds. As used herein, an herbicidally effective or vegetation controlling amount is an amount of active ingredient that causes an “herbicidal effect,” i.e., an adversely modifying effect and includes deviations from natural development, killing, regulation, desiccateon, retardation.

The term “Herbicide resistance” as used herein, shall refers to a plant's ability to survive and reproduce after exposure to a herbicide dose that would normally kill it, often developed through genetic mutation and selection pressure. The term “herbicide tolerant” as used herein, shall refer to a plant that has a natural ability to withstand a certain level of herbicide without any genetic modification.

The term phytotoxicity as used herein refers to adverse effects on plant growth, physiology, or metabolism caused by an herbicide.

As used herein, a herbicidally effective or vegetation controlling amount is an amount of active ingredient that causes a “herbicidal effect,” i.e., an adversely modifying effect and includes deviations from natural development, killing, regulation, desiccation, retardation stunting, dwarfing and the like.

The terms “plants” and “vegetation” include, but are not limited to, germinant seeds, emerging seedlings, plants emerging from vegetative propagules, and established vegetation.

The terms “undesirable vegetation”, “harmful plants”, “unwanted plants”, “weeds” and “weed species”, as used herein, are synonyms.

The term “locus” as used herein shall denote the vicinity of a desired crop in which weed control, typically selective weed control is desired. The locus includes the vicinity of desired crop plants wherein the weed infestation has either emerged or is yet to emerge.

The term “crop” shall include a multitude of desired crop plants or an individual crop plant growing at a locus.

References to the term g ai/ha or g A/ha refer to grams of active ingredient per hectare of area.

Each of the aspects described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

The inventors of the instant application surprisingly found that a storage stable agrochemical formulation comprising a triazolone herbicide and a triazinone herbicide can be obtained by formulating a triazolone herbicide and a triazinone herbicide along with a crystal growth inhibitor and specific surfactants described herein. The inventors of the present invention observed that the formulation developed using a combination of a crystal growth inhibitor and specific surfactant and dispersion agents, as described herein, remained stable during ambient as well as accelerated heat stability test conditions. Thus, the instant application provides a storage stable agrochemical formulation, wherein the combination of a crystal growth inhibitor, specific surfactant and dispersion agents do not favor Ostwald ripening and the formulation remains stable throughout the shelf life and upon dilution before applying.

Further, the inventors of the present application surprisingly found that the herbicidal composition described herein results in an effective control of undesirable plants, at the locus of the desired plant, controls the growth of weeds, and reduces phytotoxicity in crop plants.

In one aspect, the present disclosure provides an herbicidal composition comprising at least one triazolone herbicide and at least one triazinone herbicide.

In an embodiment, the present disclosure provides an herbicidal composition comprising
i) at least one triazolone herbicide;
ii) at least one triazinone herbicide; and
iii) a crystal growth inhibitor.

In another embodiment, the herbicidal composition comprises
i) at least one triazolone herbicide;
ii) at least one triazinone herbicide;
iii) a crystal growth inhibitor;
iii at least one anionic surfactant; and
iv) at least one agrochemically acceptable excipient.

In an embodiment the triazolone herbicide, is selected from the group comprising amicarbazone, bencarbazone, carfentrazone, flucarbazone, ipfencarbazone, propoxycarbazone, sulfentrazone, and thiencarbazone.

In a preferred embodiment, the triazolone herbicide is amicarbazone.

In an embodiment, the triazinone herbicide is selected from the group comprising metribuzin, ametridione, amibuzin, ethiozin, hexazinone, isomethiozin, and metamitron.

In a preferred embodiment, the triazinone herbicide is metribuzin.

In an embodiment, the triazolone herbicide and triazinone herbicide, in the herbicidal composition are present in a ratio ranging from 1:1 to 2:1. In one aspect of an embodiment described herein, the ratio of the triazolone herbicide to the triazinone herbicide is 1.11:1. In another aspect of an embodiment described herein, the ratio of the triazolone herbicide to the triazinone herbicide is 1.12:1. In yet another aspect of an embodiment described herein, the ratio of the triazolone herbicide to the triazinone herbicide is 1.13:1. In yet another aspect of an embodiment described herein, the ratio of the triazolone herbicide to the triazinone herbicide is 1.14:1. In yet another aspect of an embodiment described herein, the ratio of the triazolone herbicide to the triazinone herbicide is 1.15:1. In yet another aspect of an embodiment described herein, the ratio of the triazolone herbicide to the triazinone herbicide is 1.16:1. In yet another aspect of an embodiment described herein, the ratio of the triazolone herbicide to the triazinone herbicide is 1.17:1. In yet another aspect of an embodiment described herein, the ratio of the triazolone herbicide to the triazinone herbicide is 1.18:1. In yet another aspect of an embodiment described herein, the ratio of the triazolone herbicide to the triazinone herbicide is 1.19:1. In yet another aspect of an embodiment described herein, the ratio of the triazolone herbicide to the triazinone herbicide is 1.2:1. In yet another aspect of an embodiment described herein, the ratio of the triazolone herbicide to the triazinone herbicide is 1.21:1. In yet another aspect of an embodiment described herein, the ratio of the triazolone herbicide to the triazinone herbicide is 1.22:1. In yet another aspect of an embodiment described herein, the ratio of the triazolone herbicide to the triazinone herbicide is 1.23:1. In yet another aspect of an embodiment described herein, the ratio of the triazolone herbicide to the triazinone herbicide is 1.24:1. In yet another aspect of an embodiment described herein, the ratio of the triazolone herbicide to the triazinone herbicide is 1.25:1. In yet another aspect of an embodiment described herein, the ratio of the triazolone herbicide to the triazinone herbicide is 1.26:1. In yet another aspect of an embodiment described herein, the ratio of the triazolone herbicide to the triazinone herbicide is 1.27:1. In yet another aspect of an embodiment described herein, the ratio of the triazolone herbicide to the triazinone herbicide is 1.28:1. In yet another aspect of an embodiment described herein, the ratio of the triazolone herbicide to the triazinone herbicide is 1.29:1. In yet another aspect of an embodiment described herein, the ratio of the triazolone herbicide to the triazinone herbicide is 1.3:1. In yet another aspect of an embodiment described herein, the ratio of the triazolone herbicide to the triazinone herbicide is 1.31:1. In yet another aspect of an embodiment described herein, the ratio of the triazolone herbicide to the triazinone herbicide is 1.32:1. In yet another aspect of an embodiment described herein, the ratio of the triazolone herbicide to the triazinone herbicide is 1.33:1. In yet another aspect of an embodiment described herein, the ratio of the triazolone herbicide to the triazinone herbicide is 1.34:1. In yet another aspect of an embodiment described herein, the ratio of the triazolone herbicide to the triazinone herbicide is 1.35:1. In yet another aspect of an embodiment described herein, the ratio of the triazolone herbicide to the triazinone herbicide is 1.36:1. In yet another aspect of an embodiment described herein, the ratio of the triazolone herbicide to the triazinone herbicide is 1.37:1. In yet another aspect of an embodiment described herein, the ratio of the triazolone herbicide to the triazinone herbicide is 1.38:1. In yet another aspect of an embodiment described herein, the ratio of the triazolone herbicide to the triazinone herbicide is 1.39:1. In yet another aspect of an embodiment described herein, the ratio of the triazolone herbicide to the triazinone herbicide is 1.4:1. In yet another aspect of an embodiment described herein, the ratio of the triazolone herbicide to the triazinone herbicide is 1.5:1. In yet another aspect of an embodiment described herein, the ratio of the triazolone herbicide to the triazinone herbicide is 1.51:1. In yet another aspect of an embodiment described herein, the ratio of the triazolone herbicide to the triazinone herbicide is 1.52:1. In yet another aspect of an embodiment described herein, the ratio of the triazolone herbicide to the triazinone herbicide is 1.53:1. In yet another aspect of an embodiment described herein, the ratio of the triazolone herbicide to the triazinone herbicide is 1.54:1. In yet another aspect of an embodiment described herein, the ratio of the triazolone herbicide to the triazinone herbicide is 1.55:1. In yet another aspect of an embodiment described herein, the ratio of the triazolone herbicide to the triazinone herbicide is 1.56:1. In yet another aspect of an embodiment described herein, the ratio of the triazolone herbicide to the triazinone herbicide is 1.57:1. In yet another aspect of an embodiment described herein, the ratio of the triazolone herbicide to the triazinone herbicide is 1.58:1. In yet another aspect of an embodiment described herein, the ratio of the triazolone herbicide to the triazinone herbicide is 1.59:1. In yet another aspect of an embodiment described herein, the ratio of the triazolone herbicide to the triazinone herbicide is 1.6:1. In yet another aspect of an embodiment described herein, the ratio of the triazolone herbicide to the triazinone herbicide is 1.61:1. In yet another aspect of an embodiment described herein, the ratio of the triazolone herbicide to the triazinone herbicide is 1.62:1. In yet another aspect of an embodiment described herein, the ratio of the triazolone herbicide to the triazinone herbicide is 1.63:1. In yet another aspect of an embodiment described herein, the ratio of the triazolone herbicide to the triazinone herbicide is 1.64:1. In yet another aspect of an embodiment described herein, the ratio of the triazolone herbicide to the triazinone herbicide is 1.65:1. In yet another aspect of an embodiment described herein, the ratio of the triazolone herbicide to the triazinone herbicide is 1.66:1. In yet another aspect of an embodiment described herein, the ratio of the triazolone herbicide to the triazinone herbicide is 1.67:1. In yet another aspect of an embodiment described herein, the ratio of the triazolone herbicide to the triazinone herbicide is 1.68:1. In yet another aspect of an embodiment described herein, the ratio of the triazolone herbicide to the triazinone herbicide is 1.69:1. In yet another aspect of an embodiment described herein, the ratio of the triazolone herbicide to the triazinone herbicide is 1.7:1. In yet another aspect of an embodiment described herein, the ratio of the triazolone herbicide to the triazinone herbicide is 1.71:1. In yet another aspect of an embodiment described herein, the ratio of the triazolone herbicide to the triazinone herbicide is 1.72:1. In yet another aspect of an embodiment described herein, the ratio of the triazolone herbicide to the triazinone herbicide is 1.73:1. In yet another aspect of an embodiment described herein, the ratio of the triazolone herbicide to the triazinone herbicide is 1.74:1. In yet another aspect of an embodiment described herein, the ratio of the triazolone herbicide to the triazinone herbicide is 1.75:1. In yet another aspect of an embodiment described herein, the ratio of the triazolone herbicide to the triazinone herbicide is 1.76:1. In yet another aspect of an embodiment described herein, the ratio of the triazolone herbicide to the triazinone herbicide is 1.77:1. In yet another aspect of an embodiment described herein, the ratio of the triazolone herbicide to the triazinone herbicide is 1.78:1. In yet another aspect of an embodiment described herein, the ratio of the triazolone herbicide to the triazinone herbicide is 1.79:1. In yet another aspect of an embodiment described herein, the ratio of the triazolone herbicide to the triazinone herbicide is 1.8:1. In yet another aspect of an embodiment described herein, the ratio of the triazolone herbicide to the triazinone herbicide is 1.81:1. In yet another aspect of an embodiment described herein, the ratio of the triazolone herbicide to the triazinone herbicide is 1.82:1. In yet another aspect of an embodiment described herein, the ratio of the triazolone herbicide to the triazinone herbicide is 1.83:1. In yet another aspect of an embodiment described herein, the ratio of the triazolone herbicide to the triazinone herbicide is 1.84:1. In yet another aspect of an embodiment described herein, the ratio of the triazolone herbicide to the triazinone herbicide is 1.85:1. In yet another aspect of an embodiment described herein, the ratio of the triazolone herbicide to the triazinone herbicide is 1.86:1. In yet another aspect of an embodiment described herein, the ratio of the triazolone herbicide to the triazinone herbicide is 1.87:1. In yet another aspect of an embodiment described herein, the ratio of the triazolone herbicide to the triazinone herbicide is 1.88:1. In yet another aspect of an embodiment described herein, the ratio of the triazolone herbicide to the triazinone herbicide is 1.89:1. In yet another aspect of an embodiment described herein, the ratio of the triazolone herbicide to the triazinone herbicide is 1.9:1. In yet another aspect of an embodiment described herein, the ratio of the triazolone herbicide to the triazinone herbicide is 1.91:1. In yet another aspect of an embodiment described herein, the ratio of the triazolone herbicide to the triazinone herbicide is 1.92:1. In yet another aspect of an embodiment described herein, the ratio of the triazolone herbicide to the triazinone herbicide is 1.93:1. In yet another aspect of an embodiment described herein, the ratio of the triazolone herbicide to the triazinone herbicide is 1.94:1. In yet another aspect of an embodiment described herein, the ratio of the triazolone herbicide to the triazinone herbicide is 1.95:1. In yet another aspect of an embodiment described herein, the ratio of the triazolone herbicide to the triazinone herbicide is 1.96:1. In yet another aspect of an embodiment described herein, the ratio of the triazolone herbicide to the triazinone herbicide is 1.97:1. In yet another aspect of an embodiment described herein, the ratio of the triazolone herbicide to the triazinone herbicide is 1.98:1. In yet another aspect of an embodiment described herein, the ratio of the triazolone herbicide to the triazinone herbicide is 1.99:1. In yet another aspect of an embodiment described herein, the ratio of the triazolone herbicide to the triazinone herbicide is 2:1. In yet another aspect of an embodiment described herein, the ratio of the triazolone herbicide to the triazinone herbicide can range between any pair of the preceding values, such as 1.1:1 to 1.9:1, 1.3:1 to 1.8:1, or 1.5:1 to 1.8:1.

In an embodiment, a herbicidal composition comprises a triazolone herbicide in an amount ranging from 10% w/w to 50% w/w of the total weight of the composition. In some embodiments, the triazolone herbicide is present in an amount of 10.1% w/w, 10.2% w/w, 10.3% w/w, 10.4% w/w, 10.5% w/w, 10.6% w/w, 10.7% w/w, 10.8% w/w, 10.9% w/w, 11%, 12%, 13% 14%, 15%, 16%, 17%, 18%, 19%, 20%, 20.1% w/w, 20.2% w/w, 20.3% w/w, 20.4% w/w, 20.5% w/w, 20.6% w/w, 20.7% w/w, 20.8% w/w, 20.9% w/w, 21% w/w, 21.1% w/w, 21.2% w/w, 21.3% w/w, 21.4% w/w, 21.5% w/w, 21.6% w/w, 21.7% w/w, 21.8% w/w, 21.9% w/w, 22% w/w, 22.1% w/w, 22.2% w/w, 22.3% w/w, 22.4% w/w, 22.5% w/w, 22.6% w/w, 22.7% w/w, 22.8% w/w, 22.9% w/w, 23% w/w, 23.1% w/w, 23.2% w/w, 23.3% w/w, 23.4% w/w, 23.5% w/w, 23.6% w/w, 23.63% w/w, 23.7% w/w, 23.8% w/w, 23.9% w/w, 24% w/w, 24.1% w/w, 24.2% w/w, 24.3% w/w, 24.4% w/w, 24.5% w/w, 24.6% w/w, 24.7% w/w, 24.8% w/w, 24.9% w/w, 25% w/w, 25.1% w/w, 25.2% w/w, 25.3% w/w, 25.4% w/w, 25.5% w/w, 25.6% w/w, 25.7% w/w, 25.8% w/w, 25.9% w/w, 26% w/w, 26.1% w/w, 26.2% w/w, 26.3% w/w, 26.4% w/w, 26.5% w/w, 26.6% w/w, 26.7% w/w, 26.8% w/w, 26.9% w/w, 27% w/w, 27.1% w/w, 27.2% w/w, 27.3% w/w, 27.4% w/w, 27.5% w/w, 27.6% w/w, 27.7% w/w, 27.8% w/w, 27.9% w/w, 28% w/w, 28.1% w/w, 28.2% w/w, 28.3% w/w, 28.4% w/w, 28.5% w/w, 28.6% w/w, 28.7% w/w, 28.8% w/w, 28.9% w/w, 29% w/w, 29.1% w/w, 29.2% w/w, 29.3% w/w, 29.4% w/w, 29.5% w/w, 29.6% w/w, 29.7% w/w, 29.8% w/w, 29.9% w/w, or 30% w/w of the total weight of the composition, or in an amount within any range defined between any pair of the preceding values, such as 10% w/w to 25% w/w, 15% w/w to 25% w/w, 20% w/w to 25% w/w or 22.4% w/w to 23.8% w/w of the total weight of the composition.

In an embodiment, a herbicidal composition comprises a triazinone herbicide in an amount ranging from 5% w/w to 30% w/w of the total weight of the composition. In some embodiments, the triazinone herbicide is present in an amount of 5% w/w, 6% w/w, 7% w/w, 8% w/w, 9% w/w, 10% w/w, 10.1% w/w, 10.2% w/w, 10.3% w/w, 10.4% w/w, 10.5% w/w, 10.6% w/w, 10.7% w/w, 10.8% w/w, 10.9% w/w, 11% w/w, 11.1% w/w, 11.2% w/w, 11.3% w/w, 11.4% w/w, 11.5% w/w, 11.6% w/w, 11.7% w/w, 11.8% w/w, 11.9% w/w, 12% w/w, 12.1% w/w, 12.2% w/w, 12.3% w/w, 12.4% w/w, 12.42% w/w, 12.44% w/w, 12.46% w/w, 12.48% w/w, 12.5% w/w, 12.6% w/w, 12.7% w/w, 12.8% w/w, 12.9% w/w, 13% w/w, 13.1% w/w, 13.2% w/w, 13.3% w/w, 13.4% w/w, 13.5% w/w, 13.6% w/w, 13.7% w/w, 13.72% w/w, 13.74% w/w, 13.76% w/w, 13.78% w/w, 13.8% w/w, 13.9% w/w, 14% w/w, 14.1% w/w, 14.2% w/w, 14.3% w/w, 14.4% w/w, 14.5% w/w, 14.6% w/w, 14.7% w/w, 14.8% w/w, 14.9% w/w, 15% w/w, 16% w/w, 17% w/w, 18% w/w, 19% w/w or 20% w/w of the total weight of the composition, or in an amount within any range defined between any pair of the preceding values, such as 10% w/w to 20% w/w, 12% w/w to 15% w/w, or 12.46% to 13.78% w/w of the total weight of the composition.

In an embodiment, an herbicidal composition comprises at least one co-polymer dispersant as a crystal growth inhibitor. In an embodiment, the present composition comprising crystal growth inhibitor in an amount ranging from 1% w/w to 20% w/w of the total weight of the formulation. In some embodiments, the crystal growth inhibitor is present in an amount of 1.0% w/w, 2.0% w/w, 2.1% w/w, 2.2% w/w, 2.3% w/w, 2.4% w/w, 2.5% w/w, 2.6% w/w, 2.7% w/w, 2.8% w/w, 2.9% w/w, 3% w/w, 3.1% w/w, 3.2% w/w, 3.3% w/w, 3.4% w/w, 3.5% w/w, 3.6% w/w, 3.7% w/w, 3.8% w/w, 3.9% w/w, 4% w/w, 4.1% w/w, 4.2% w/w, 4.3% w/w, 4.4% w/w, 4.5% w/w, 4.6% w/w, 4.7% w/w, 4.8% w/w, 4.9% w/w, 5.0% w/w, 5.1% w/w, 5.2% w/w, 5.3% w/w, 5.4% w/w, 5.5% w/w, 5.6% w/w, 5.7% w/w, 5.8% w/w, 5.9% w/w, 6% w/w, 6.1% w/w, 6.12% w/w, 6.14% w/w, 6.16% w/w, 6.18% w/w, 6.2% w/w, 6.3% w/w, 6.4% w/w, 6.5% w/w, 6.6% w/w, 6.7% w/w, 6.8% w/w, 6.82% w/w, 6.z % w/w, 6.84% w/w, 6.86% w/w, 6.88% w/w, 6.9% w/w, 7% w/w, 7.1% w/w, 7.2% w/w, 7.3% w/w, 7.4% w/w, 7.5% w/w, 7.6% w/w, 7.7% w/w, 7.8% w/w, 7.9% w/w, or 8% w/w of the total weight of the composition, or in an amount within any range defined between any pair of the preceding values, such as 5.5% w/w to 7.5% w/w, 6.1% w/w to 6.9% w/w, or 6.18% w/w to 6.82% w/w of the total weight of the composition.

In some embodiments, the crystal growth inhibitor is an acrylic co-polymer. In an embodiment, acrylic co-polymer is present in compositions from about 1% to about 20% w/w of the total weight of the composition. In an embodiment, acrylic co-polymer is present in compositions at a concentration from about 1% to about 15% w/w of the total weight of the composition. In an embodiment, acrylic co-polymer is present in compositions at a concentration from about 1% to about 10% w/w of the total weight of the composition. In an embodiment, acrylic co-polymer is present in compositions at a concentration from about 2% to about 8% w/w of the total weight of the composition.

In an embodiment the present composition comprises a surfactant component. In an embodiment the surfactant component comprises a graft copolymer and polyalkylene oxide block copolymer. The graft copolymer surfactant in compositions of the present invention is present in a amount from about 1% to about 10% w/w of the total weight of the composition. The graft copolymer surfactant in compositions of the present invention is present in an amount from about 1% to about 5% w/w of the total weight of the composition. The polyalkylene oxide block copolymer in compositions of the present invention is present in an amount from about 0.1% to about 10% w/w of the total weight of the composition. The polyalkylene oxide block copolymer in compositions of the present invention is present in an amount from about 0.1% to about 5% w/w of the total weight of the composition. The polyalkylene oxide block copolymer in compositions of the present invention is present in an amount from about 0.1% to about 2% w/w of the total weight of the composition.

In an embodiment, an agrochemical composition further comprises one or more agrochemically acceptable excipient selected from surfactants, wetting agents, antifreezing agents, carriers, fillers, solvents, stabilizers, thickeners, preservatives, biocides, antifoaming agents, colorants, and other formulation aids.

In an embodiment, the agriculturally acceptable dispersing agents to enable disintegration of granules in water with ease, such as alkoxylated tristyryl phenol phosphates, tristyryl phenol ethoxylated (POE-16) phosphate polyacrylates, alkylarylsulfonic acid salts, dialkylsulfosuccinate salts, ether sulfates and phosphate esters can be used in the composition. In an embodiment, the dispersing agents is used in an amount from about 1% to about 10% w/w, preferably from about 1% to about 5% w/w of the total weight of the composition.

In an embodiment, water may be present in compositions of the present invention at a concentration from about 1% to about 99% w/w, preferably from about 10% to about 80% w/w, more preferably from about 10% to about 70% w/w and even more preferably from about 10% to about 60% w/w and most preferably between about 30% to 50% w/w the total weight of the composition.

In one embodiment, the thickeners or rheology modifier suitable for use in the present invention include, but are not limited to, hydroxyethyl cellulose, magnesium aluminum silicate, attapulgite clay, hydrophilic fumed silica, aluminum oxide, xanthan gum and mixtures thereof.

Thickeners may be present in compositions of the present invention at a concentration from about 0.01% to about 5% w/w, preferably from about 0.01% to about 2% w/w, more preferably form about 0.01% to about 1% w/w the total weight of the composition.

In some embodiments, the antifoaming agent is selected from polydimethylsiloxane, silicone oil and magnesium stearate or a suitable combination thereof.

Anti-foam agents may be present in compositions of the present invention at a concentration from about 0.01% to about 1% w/w, preferably from about 0.05% to about 0.5% w/w, more preferably form about 0.2% to about 0.4% w/w and even more preferably at about 0.2% w/w of the total weight of the composition.

In some embodiments, preservatives suitable for use in the present invention include, but are not limited to, 2-bromo-2-nitro-1,3-propanediol, 5-chloro-2-methyl-4-isothiazolin-3-one and 2-methyl-4-isothiazolin-3-one solution in water, 2-benzisothiazolin-3-one and mixtures thereof. The preservative can be present in compositions of the present invention at a concentration from about 0.01% to about 5% w/w, preferably from about 0.1% to about 5% w/w, more preferably form about 0.1% to about 1% w/w and even more preferably at about 0.2% w/w of the total weight of the composition.

In some embodiments, the antifreeze agent is selected from polyols, propylene glycol or other low molecular weight alcohols. In an embodiment the antifreeze agent is glycerin. The antifreeze agent can be present in compositions of the present invention at a concentration from about 1% to about 10% w/w, preferably from about 1% to about 8% w/w of the total weight of the composition.

In an embodiment, the present herbicidal composition comprises amicarbazone as a triazolone herbicide, metribuzin as a triazinone herbicide, a crystal growth inhibitor and at least one agrochemically acceptable excipient.

In some embodiments, the present herbicidal composition comprises amicarbazone, metribuzin, an acrylic copolymer and an agrochemically acceptable excipient.

In some embodiments, the present herbicidal composition comprises amicarbazone, metribuzin, acrylic copolymer, polyalylene oxide block copolymer, a graft copolymer based dispersant and an agrochemically acceptable excipient.

In an embodiment, the present composition is formulated as a suspension concentrate.

In an embodiment, the present invention provides a suspension concentrate comprising amicarbazone, metribuzin, a crystal growth inhibitor and an agrochemically acceptable excipient.

In an embodiment, the present invention provides a suspension concentrate comprising amicarbazone, metribuzin, an acrylic copolymer and an agrochemically acceptable excipient.

In an embodiment, the present invention provides a suspension concentrate comprising 1% to about 50% w/w of amicarbazone, 5% to about 30% w/w of metribuzin, 1% to about 20% w/w of acrylic copolymer of the total weight of the composition and an agrochemically acceptable excipient.

In an embodiment, the present invention provides a suspension concentrate comprising 1% to about 50% w/w of amicarbazone, 5% to about 30% w/w of metribuzin, 1% to about 20% w/w of acrylic copolymer, 0.1% to about 10% w/w of polyalkylene oxide block copolymer, 1% to about 10% w/w of a graft copolymer based dispersant and an agrochemically acceptable excipient.

In an embodiment, the present composition discloses a process for preparing an agrochemical composition comprising a triazolone herbicide and a triazinone herbicide.

In an embodiment, a process for the preparation of an agrochemical composition comprising a triazolone herbicide and a triazinone herbicide comprises admixing a triazolone herbicide and a triazinone herbicide with a crystal growth inhibitor and an agrochemically acceptable excipient.

In an embodiment, the process further comprises milling the resulting mixture to reduce particle size of suspended particles. In an embodiment, the process further comprises admixing thickening agents; antifreezing agents, preservatives and optionally other auxiliary ingredients; and preparing the composition.

In another embodiment described herein, a process for preparing an agrochemical composition comprising: (a) homogenizing the agrochemically acceptable excipients to obtain a homogenized mixture, (b) adding amicarbazone and metribuzin, to the homogenized mixture, (d) continue homogenization to obtain a slurry mix, (c) milling the slurry mixture to obtain the formulation.

In an embodiment, the process of milling comprises obtaining a uniform dispersion.

In an embodiment, the dispersion is optionally jellified to obtain a suspension concentrate.

In an embodiment, the present invention discloses a process for preparing a suspension concentrate composition comprising: (a) homogenizing the agrochemically acceptable excipients to obtain a homogenized mixture, (b) adding amicarbazone and metribuzin, to the homogenized mixture, (d) continue homogenization to obtain a slurry mix, (c) milling the slurry mixture to obtain formulation.

In an embodiment, the agrochemical composition described herein has a particle size distribution (D50) of less than 10.0 microns. In some embodiments, an agrochemical composition described herein has a particle size distribution (D50) of less than 9.0 microns, less than 8.0 microns, less than 7.0 microns, less than 6.0 microns, less than 4.0 microns, less than 3.0 microns, between 3.0 microns to 5.0 microns, between 2.5 microns to 4.5 microns, or between 2 microns to 5 microns.

Advantageously, the herbicidal composition of the present invention is stable and can be stored for a long period retaining its herbicidal activity and suspensibility and without forming crystals.

In one embodiment, the herbicidal composition of the present invention retains stability when stored at ambient temperatures for 3 months. In a preferred embodiment, the herbicidal composition is stable under AHS conditions that is at 54° C. for two weeks.

In an embodiment, the present invention provides preferred compositions and methods thereof. The methods of the invention include a method of controlling weeds at a locus by applying to the locus the composition, a method of increasing yield in a crop by application of the combination or composition, or a method of improving the plant health by application at the locus of the plant the composition. The embodiments described herein describe the preferred embodiments of all these possible compositions and methods of the invention.

The present composition can be applied to the locus of the weeds, in an herbicidally effective amount.

In an embodiment, the combination of the present invention may be combined with at least another active ingredient such as those selected from but not limited to herbicide, insecticide, fungicide, biological agent, plant growth activator, fertilizers or combinations thereof.

In an embodiment, the present disclosure provides use of an herbicidal composition comprising amicarbazone and metribuzin for controlling weeds.

In an embodiment, the composition of the present disclosure is effective in controlling target weeds selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE), Xanthium strumarium (common cocklebur, XANST), Lamium purpureum (LAMPU), Stellaria media (STEME), Cyanus segetum (CENCY), or Galium aparine (GALAP).

In yet another embodiment, the present disclosure provides a method of improving the plant health, the method comprising, applying to the plant or to the locus at which said plant is growing or intended to grow an herbicidal composition as described herein.

According to an embodiment of the present disclosure, there is provided a method of controlling weeds by applying to the plants or to their locus, an agrochemical composition comprising: amicarbazone, metribuzin, an acrylic copolymer and an agrochemically acceptable excipient.

According to an embodiment of the present disclosure, there is provided a method of controlling weeds by applying to the plants or to their locus, an agrochemical composition comprising amicarbazone, metribuzin, acrylic copolymer, polyalylene oxide block copolymer, a graft copolymer based dispersant and an agrochemically acceptable excipient.

In one aspect of an embodiment described herein, the triazolone herbicide, such as amicarbazone, is applied in an amount ranging 100 g ai/ha to 600 g ai/ha. In some embodiments, the triazolone herbicide is applied in an amount of 125 g ai/ha, 150 g ai/ha, 175 g ai/ha, 183 g ai/ha, 200 g ai/ha, 211.8 g ai/ha, 225 g ai/ha, 250 g ai/ha, 250.3 g ai/ha, 274 g ai/ha, 275 g ai/ha, 300 g ai/ha, 325 g ai/ha, 350 g ai/ha, 366 g ai/ha, 375 g ai/ha, 400 g ai/ha, 425 g ai/ha, 450 g ai/ha, 475 g ai/ha, 494 g ai/ha, 500 g ai/ha, 525 g ai/ha, 550 g ai/ha, 5575 g ai/ha, or 600 g ai/ha, or at a rate within any range defined between any pair of the preceding values, such as, 180 g ai/ha-500 g ai/ha, 180 g ai/ha-366 g ai/ha, or 180 g ai/ha-500 g ai/ha.

In one aspect of an embodiment described herein, the triazinone herbicide, such as metribuzin, is applied at a rate of ranging 100 g ai/ha to 300 g ai/ha. In some embodiments, the triazolone herbicide is applied in an amount of 105 g ai/ha, 125 g ai/ha, 150 g ai/ha, 158 g ai/ha, 175 g ai/ha, 200 g ai/ha, 210 g ai/ha, 225 g ai/ha, 250 g ai/ha, 270.5 g ai/ha, 275 g ai/ha, 280 g ai/ha, or 300 g ai/ha, or at a rate within any range defined between any pair of the preceding values, such as, 100 g ai/ha-210 g ai/ha, 150 g ai/ha-300 g ai/ha, or 105 g ai/ha-280 g ai/ha.

According to an embodiment, the composition according to the present disclosure may be applied either pre or post emergent. The advantage of the composition is surprisingly good residual effects, when applied in pre-emergent as well as quick knockdown when applied post emergent leading to quick control of weeds.

The combinations and the compositions of the present invention may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present invention are used in the customary manner, for example by watering, spraying, atomizing, dusting or scattering.

The compositions of the present invention can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

According to an embodiment described herein, the various components of the agrochemical composition can be used individually or already partially or completely mixed with one another to prepare the composition according to the invention. It is also possible for them to be packaged and used further as combination composition such as a kit of parts.

According to an embodiment of the present disclosure, a kit-of-parts comprising an agrochemical composition is provided. The kit comprises a plurality of components, each of which components may include at least one of the ingredients of the agrochemical composition of the present disclosure.

In one embodiment described herein, the kits may include one or more, including all, components that may be used to prepare the agrochemical composition. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i.e., not pre-formulated. As such, kits may include one or more separate containers such as vials, cans, bottles, pouches, bags or canisters, each container containing a separate component for the agrochemical composition.

In both forms, a component of the kit may be applied separately from or together with the further components or as a component of a combination composition according to one aspect of the embodiment for preparing the agrochemical composition according to the invention.

The present composition obtained has a superior suspensibility, better dispersibility and no sedimentation.

In an embodiment the present compositions have advantageous properties such as resistance management, causing minimal damage to the environment, and a herbicidal composition that has excellent residual effects.

Thus, present invention described herein provides a method of controlling weeds thereby providing resistance management and significant control of the weeds. The invention also provides an adequate method to achieve complete control of weeds, improving yields, while targeting resistance management.

Furthermore, the present disclosure provides a method of controlling chlorotriazine resistant or tolerant weeds comprising applying a triazolone herbicide, a triazinone herbicide, or an herbicidal composition comprising a triazolone herbicide and a triazinone herbicide.

In yet another embodiment, the method for controlling weeds at a locus, comprising applying to the locus a triazolone herbicide, wherein the weed is resistant or tolerant to a chlorotriazine. In one aspect of the embodiment, the weed is resistant or tolerant to a chlorotriazine at normal field use rates.

In yet another embodiment, the method for controlling weeds at a locus, comprising applying to the locus a triazinone herbicide, wherein the weed is resistant or tolerant to a chlorotriazine. In one aspect of the embodiment, the weed is resistant or tolerant to a chlorotriazine at normal field use rates.

In yet another embodiment, the method for controlling weeds at a locus comprising applying to the locus an herbicidal composition described herein, wherein the weed is resistant or tolerant to a chlorotriazine. In one aspect of the embodiment, the weed is resistant or tolerant to a chlorotriazine at normal field use rates.

In an embodiment disclosed herein, the chlorotriazine herbicide is atrazine.

In an embodiment the present invention provides a method of controlling the herbicide resistant weeds comprising applying to a locus an herbicidal composition comprising at least one triazolone herbicide and at least one triazinone herbicide.

In another embodiment, the method of controlling the herbicide resistant weeds comprising applying to a locus the herbicidal composition comprising amicarbazone and metribuzin.

In some embodiments, the method of controlling the herbicide resistant weeds comprising applying to a locus the herbicidal composition comprising amicarbazone and metribuzin, the herbicide resistant weeds are atrazine resistant weeds.

In some embodiment, the present disclosure provides a method of controlling Setaria faberi comprising applying a composition comprising a triazolone herbicide and a triazinone herbicide, wherein the triazolone herbicide is amicarbazone, applied at a rate ranging from about 183 g ai/ha to about 497 g ai/ha and the triazinone herbicide is metribuzin applied at a rate ranging from about 105 g ai/ha to about 280 g ai/ha.

In another embodiment, the present disclosure provides a method of controlling Amaranthus tuberculatus comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate ranging from about 105 g ai/ha to about 280 g ai/ha.

In another embodiment, the instant disclosure provides a method of controlling Digitaria sanguinalis comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate from about 105 g ai/ha to about 280 g ai/ha.

In another embodiment, the instant disclosure provides a method of controlling Abutilon theophrasti comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate ranging from about 105 g ai/ha to about 280 g ai/ha.

In another embodiment, the instant disclosure provides a method of controlling Raphamus raphanistrum comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate in the range from about 105 g ai/ha to about 280 g ai/ha.

In another embodiment, the instant disclosure provides a method of controlling Amaranthus palmeri comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate in the range from about 105 g ai/ha to about 280 g ai/ha.

In another embodiment, the instant disclosure provides a method of controlling Setaria faberi comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate ranging from about 105 g ai/ha to about 280 g ai/ha.

In another embodiment, the instant disclosure provides a method of controlling Amaranthus tuberculatus comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate ranging from about 105 g ai/ha to about 280 g ai/ha.

In another embodiment, the instant disclosure provides a method of controlling Digitaria sanguinalis comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate from about 105 g ai/ha to about 280 g ai/ha.

In another embodiment, the instant disclosure provides a method of controlling Abutilon theophrasti comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate ranging from about 105 g ai/ha to about 280 g ai/ha.

In another embodiment, the instant disclosure provides a method of controlling Raphamus raphanistrum comprising applying a composition comprising a triazolone herbicide and a triazinone herbicide, wherein the triazolone herbicide is applied at a rate ranging from about 183 g ai/ha to about 497 g ai/ha and the triazinone herbicide is applied at a rate in the range from about 105 g ai/ha to about 280 g ai/ha.

In another embodiment, the instant disclosure provides a method of controlling Amaranthus palmeri comprising applying a combination of a triazolone herbicide and a triazinone herbicide, wherein the triazolone herbicide is applied at a rate ranging from about 183 g ai/ha to about 497 g ai/ha and the triazinone herbicide is applied at a rate in the range from about 105 g ai/ha to about 280 g ai/ha.

All the features described herein may be combined with any of the above aspects or any of above-described embodiment, in any combination.

These representative embodiments are in no way limiting and are described solely to illustrate some aspects of the invention. Further, the following examples are offered by way of illustration only and not by way of limitation.

### EXAMPLES

### Example 1

### Formulation 1—Amicarbazone+Metribuzin Suspension Concentrate (SC)

| | | QUANTITY IN |
|---|---|---|
| S. NO. | INGREDIENTS | % (w/w) |
| 1 | Amicarbazone | 23.63 |
| 2 | Metribuzin | 13.50 |
| 3 | Graft co-polymer | 2.5 |
| 4 | Polyalkylene oxide block | 1.0 |
| | co-polymer | |
| 5 | Acrylic co-polymer | 6.5 |
| 6 | Tristyrylphenol | 3.0 |
| | ethoxylate, POE-16 | |
| | phosphate ester | |
| 7 | Water | Q.S. |
| | Total | 100 |

amicarbazone (97.8%), metribuzin (97.2%), molten polyalkylene oxide block co-polymer, graft co-polymer, acrylic co-polymer, tristyrylphenol ethoxylate, POE-16 phosphate ester, and sufficient quantity of water were charged in quantities mentioned in the above table in a homogenizer. Homogenization was carried out for 1 hour 30 minutes to obtain homogenized mixture. The homogenized mixture was then fed to the wet grinding mill for particle size reduction. The uniform mixture thus obtained in milling was then mixed in gellification vessel containing pre-formulated 1.5% gel to obtain suspension concentrate.

### Stability Study Data:

Stability features associated with the formulation developed according to the process described herein were studied. Formulation 1 was evaluated for physicochemical parameters. It was found that both the formulation remained stable when tested at ambient conditions, i.e., room temperature and pressure. The composition also passed 14 days Accelerated Heat Stability (AHS) test and remained flowable suspension in off-white appearance. Amount of active content was also evaluated at ambient and AHS stages. It was found that active content remained almost constant without any significant deterioration or loss. The compositions also passed wet sieve testing as no crystals were observed to be retained on wet sieve. Particle size of composition was analyzed and found to be nearly constant suggesting little/negligible particle size growth or crystal formation.

TABLE 1

| PARAMETERS | Initial | 2 Weeks |
|---|---|---|
| CONDITION | Room | 54° C. |
| | temperature | |
| | (RT) | |
| _{P}H (1% DI) | 5.37 | 5.2 |
| DENSITY (G/ML) | 1.0936 | 1.0942 |
| VISCOSITY, CP (#3, 60 RPM) | 514 | 410 |
| PARTICLE SIZE (D50) | 3.086 | 4.480 |
| APPEARANCE | Flowable white | Flowable |
| | suspension | white |
| | | suspension |

TABLE 2

| | Time point | | | | | | |
|---|---|---|---|---|---|---|---|
| | Initial | 1 MONTH | | | 3 MONTHS | | |
| Condition | RT | RT | 0° C. | 40° C. | RT | 0° C. | 40° C. |
| _{P}h (1% di) | 5.37 | 6.45 | 6.39 | 6.35 | 6.4 | 6.38 | 6.25 |
| Density (g/ml) | 1.0936 | 1.094 | 1.0934 | 1.0941 | 1.0937 | 1.094 | 1.0938 |
| Viscosity, cp | 514 | 448 | 478 | 420 | 446 | 470 | 410 |
| (#3, 60 rpm) | | | | | | | |
| Particle size | 3.086 | 4.480 | 2.550 | 3.316 | 3.151 | 2.889 | 3.042 |
| (d50) | | | | | | | |
| Appearance | Flowable | Flowable | Flowable | Flowable | Flowable | Flowable | Flowable |
| | white | white | white | white | white | white | white |
| | suspension | suspension | suspension | suspension | suspension | suspension | suspension |
| Agglomerates | Absent | Absent | Absent | Absent | Absent | Absent | Absent |

### Example 2

### Formulation 2—Amicarbazone+Metribuzin Suspension Concentrate (SC)

| | | QUANTITY IN |
|---|---|---|
| S. NO. | INGREDIENTS | % (w/w) |
| 1 | Amicarbazone | 20.00 |
| 2 | Metribuzin | 13.50 |
| 3 | Graft co-polymer | 2.5 |
| 4 | Polyalkylene oxide block | 1.0 |
| | co-polymer | |
| 5 | Acrylic co-polymer | 5.5 |
| 6 | Tristyrylphenol ethoxylate, | 3.0 |
| | POE-16 phosphate ester | |
| 7 | Polysaccharide | 0.15 |
| 8 | Water | Q.S. |
| | Total | 100 |

The formulation was prepared using the same process used for preparing as used for preparing Formulation 1, with the amounts of the ingredients as highlighted in the above table. Table 3 represents the results of storage stability study of composition.

TABLE 3

| Parameters | Formulation 2 | | |
|---|---|---|---|
| TIME POINT | Initial | 2 Weeks | |
| CONDITION | RT | 0° C. | 54° C. |
| _{P}H (1% DI) | 5.56 | 5.62 | 5.58 |
| DENSITY (G/ML) | 1.0941 | 1.095 | 1.0918 |
| VISCOSITY, CP (#3, 60 RPM) | 390 | 326 | 290 |
| PARTICLE SIZE (D50) | 2.947 | 3.024 | 4.293 |

Visual inspection of the suspension concentrates at two weeks indicated no phase separation or sedimentation indicating the composition was physically stable.

### Example 3

### Bio-Efficacy Study Data

Field trials using the present herbicide composition were carried out and the percentage control of weeds was calculated after 17 days of application (17DAA). The target crop was corn, and the results are recorded in the Table 4 below:

TABLE 4

| | | Weeds tested: | |
|---|---|---|---|
| | | | Tall waterhemp |
| | | Giant foxtail | (Amaranthus |
| | RATE | (Setaria faberi) | tuberculatus) |
| TREATMENT | (G AI/HA) | % CONTROL (17DAA) | |
| Untreated | N/A | 0 | 0 |
| Amicarbazone + | 274 + 158 | 76.25 | 86.25 |
| Metribuzin | | | |
| Amicarbazone + | 498 + 280 | 80.75 | 97.5 |
| Metribuzin | | | |

Field trials using the present herbicide composition was carried and the percentage control of various weeds was calculated after 32 days of application (32DAA). The target crop was corn, and the results are recorded in the Table 5 below:

TABLE 5

| | | Weeds tested: | | |
|---|---|---|---|---|
| | | Large | | |
| | | crabgrass | Velvetleaf | Wild radish |
| | | (Digitaria | (Abutilon | (Raphanus |
| | RATE | sanguinalis) | theophrasti) | raphanistrum) |
| TREATMENT | (G AI/HA) | % CONTROL (32DAA) | | |
| Untreated | N/A | 0 | 0 | 0 |
| Amicarbazone + | 183 + 105 | 97.5 | 93.75 | 100 |
| Metribuzin | | | | |

Field trials using a combination described herein was carried out and the percentage control of weeds was calculated after 17 days of application (17DAA). The target crop was com, and the results are recorded in the Table 6 below:

TABLE 6
Weed tested: Palmer amaranth (Amaranthus palmeri)

| TREATMENT | RATE (G AI/HA) | % CONTROL (17 DAA) |
|---|---|---|
| Untreated | N/A | 0 |
| Amicarbazone + | 183 + 105 | 70 |
| Metribuzin | | |

From the above results it can be concluded that the present herbicidal composition comprising amicarbazone and metribuzin is effective in controlling the unwanted weeds.

### Example 4

### Bio Efficacy Data of Controlling Atrazine Resistant or Tolerant Weeds

Repeated exposure of weed populations to atrazine results in resistance (i.e. failure to control of the weed populations) to atrazine at normal field use rates. The field use rate for atrazine varies based on soil type, intended weed target, density of weed pressure in treatment area, and other external factors, and usually ranges from 110 g ai/ha to 9,000 g ai/ha. Atrazine is a photosystem II (PS2) inhibiting herbicide classified in Group 5 Mode of Action by the Herbicide Resistance Action Committee (HRAC). Atrazine belongs to the chemical family triazine, also referred to in the literature as chlorotriazine. Amicarbazone and metribuzin are other examples of PS2 (Group 5) inhibiting herbicides. The field use rate for amicarbazone varies based on soil type, intended weed target, density of weed pressure in treatment area, and other external factors, and ranges from 10 g ai/ha to 2,000 g ai/ha, but more generally in the range of 25 g ai/ha to 500 g ai/ha. The field use rate for metribuzin varies based on soil type, intended weed target, density of weed pressure in treatment area, and other external factors, but usually ranges from 50 g ai/ha to 350 g ai/ha, but more generally in the range of 105 g ai/ha to 280 g ai/ha.

The problem of herbicide-resistant weeds is becoming more and more common. These biotypes usually survive when herbicides are applied at doses that effectively control the species. Resistant weed biotypes are the result of a fundamental evolutionary process. Individuals that are most adapted to a particular practice will be selected within the species and will increase within the population. Once a weed population is exposed to a herbicide that is inherently resistant to one or more plants, the herbicide kills the susceptible individuals, but the resistant individuals can survive and reproduce. With repeated use of herbicides, resistant weeds that initially appear as isolated plants or crops in the field can spread rapidly and dominate the population and soil seed banks.

The resistance mechanism of a weed to a certain herbicide can generally be described as either target site resistant (TSR) or non-target site resistant (NTSR). NTSR is sometimes referred to as metabolic resistance. TSR is generally due to a mutation in the gene sequence that encodes the protein or site of action of the given herbicide. NTSR is a broad term that may include, but is not limited to, mechanisms such as enhanced detoxification of herbicide within the cell, vacuole sequestration, multiple gene copies of the intended protein or site of action. The inventors of the instant application conducted a greenhouse experiment to determine if non-triazine PS2 herbicides can control a weed with documented, NTSR to atrazine.

### Method:

Seeds of common waterhemp weed (Amaranthus tuberculatus) were collected from fields. Three populations or biotypes were characterized for resistance to atrazine previously and were divided into two groups: known-sensitive (“WUS”) or target site resistant (“TSR”) and non-target site resistant (“ACR” or “MCR”). While having a similar resistance mechanism, ACR and MCR were collected in different geographical locations in Illinois, thus were labelled differently. Seeds from WUS, TSR, ACR, and MCR were pre-germinated on petri dishes for 4 weeks in a greenhouse at 35°/20° C. day/night. Seedlings were then transferred to plastic containers filled with a typical greenhouse potting mix. A balanced fertilizer and water were applied to allow normal growth. The greenhouse environmental conditions were typically 28/22° C. day/night. The plants were allowed to grow for approximately 2 weeks and were then grouped by height prior to herbicide application. The herbicide active ingredients were suspended or mixed with water prior to application to the plants. Concentrations of the active ingredients were applied in a log 3.16 scale of the intended 1× rate, which was 1680, 500, and 280 g ai/ha of atrazine, amicarbazone, and metribuzin, respectively. The test period was 13 days after herbicide treatment. The evaluations were carried out at using a visual scale of 0 to 100, with 0 representing no response to the herbicide and 100 representing complete plant death.

The results of the study are represented in the below tables. The effective dose of amicarbazone, metribuzin, or the herbicidal composition described herein was calculated to reduce atrazine resistant or tolerant weeds by 20%, 50%, and 80% is highlighted in tables 7 to 9 below.

TABLE 7
Sensitive “WUS” Population

| Herbicide | ED | Estimate (g ai/ha) |
|---|---|---|
| Atrazine (480 g/L FL) | 20 | 11.127 |
| | 50 | 20.926 |
| | 80 | 39.353 |
| Amicarbazone + Metribuzin | 20 | 1.235 |
| | 50 | 1.64 |
| | 80 | 2.178 |

TABLE 8
Non-Target Site Resistant “ACR” Population

| Herbicide | ED | Estimate (g ai/ha) |
|---|---|---|
| Atrazine (480 g/L FL) | 20 | 6.782 |
| | 50 | 72.204 |
| | 80 | 768.664 |
| Amicarbazone + Metribuzin | 20 | 0.924 |
| | 50 | 1.485 |
| | 80 | 2.385 |

TABLE 9
Non-Target Site Resistant “MCR” Population

| Herbicide | ED | Estimate (g ai/ha) |
|---|---|---|
| Atrazine (480 g/L FL) | 20 | 20.856 |
| | 50 | 128.662 |
| | 80 | 793.705 |
| Amicarbazone + Metribuzin | 20 | 0.275 |
| | 50 | 1.723 |
| | 80 | 10.783 |

It is evident from the above results that the rate of application of amicarbazone, metribuzin, or the herbicidal composition comprising amicarbazone and metribuzin as described herein needed to control the known-sensitive (“WUS”) or target site resistant (“TSR”) and non-target site resistant (“ACR” or “MCR”) atrazine tolerant weeds is significantly lower than the rate of application of atrazine. Thus, the present invention aimed at promoting a reduction in agrochemical use and finally reducing the cost.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

We claim:

1. An herbicidal composition comprising:
a. at least a triazolone herbicide;
b. at least a triazinone herbicide; and
c. a crystal growth inhibitor.

2. The composition as claimed in claim 1, wherein the triazolone herbicide and triazinone herbicide, in the herbicidal composition are present in a ratio ranging from 1:1 to 2:1.

3. The composition as claimed in claim 1, wherein triazolone herbicide is selected from the group comprising amicarbazone, bencarbazone, carfentrazone, flucarbazone, ipfencarbazone, propoxycarbazone, sulfentrazone, and thiencarbazone.

4. The composition as claimed in claim 1, wherein triazinone herbicide is selected from the group comprising metribuzin, ametridione, amibuzin, ethiozin, hexazinone, isomethiozin, and metamitron.

5. The composition as claimed in claim 1, wherein triazolone herbicide is amicarbazone.

6. The composition as claimed in claim 1, wherein triazinone herbicide is metribuzin.

7. The composition as claimed in claim 1, wherein triazolone herbicide is present in an amount ranging from 10% w/w to 50% w/w of the total weight of the composition.

8. The composition as claimed in claim 1, wherein triazinone herbicide is present in an amount ranging from 5% w/w to 30% w/w of the total weight of the composition.

9. The composition as claimed in claim 1, wherein the crystal growth inhibitor is an acrylic co-polymer.

10. The composition as claimed in claim 1, wherein the crystal growth inhibitor is used in an amount ranging from about 1% to about 20% w/w of the total weight of the composition.

11. The composition as claimed in claim 1, further comprises a surfactant component comprising a graft copolymer and polyalkylene oxide block copolymer.

12. The composition as claimed in claim 1, further comprises one or more agrochemically acceptable excipient.

13. The composition as claimed in claim 1, is a suspension concentrate.

14. A method of controlling undesirable vegetation comprising applying the composition according to claim 1.

15. The method as claimed in claim 14, wherein the undesirable vegetation is resistant or tolerant to atrazine.
